(19) United States
(12) Patent Application Publication
(10) Pub. No.: US 2006/0054195 A1
(43) Pub. Date: Mar. 16, 2006

(54) Dishwasher

(75) Inventors: Sang Heon Yoon, Seoul (KR); Nung Seo Park, Incheon (KR); Dae Yeong Han, Seoul (KR); Hung Myong Cho, Gyeongsangnam-do (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/055,624

(22) Filed: Feb. 11, 2005

(30) Foreign Application Priority Data
Sep. 16, 2004 (KR) P2004-74092

(51) Int. Cl. B08B 3/00

(52) U.S. Cl. 134/56 D; 134/58 D

(57) ABSTRACT

A dishwasher for completely collecting used wash water into a sump is disclosed, the dishwasher including a housing; a tub provided in the housing and receiving dishes to be washed; a sump provided at the tub so as to receive wash water and including an upper end configured not to protrude from a bottom surface of the tub; and a sprayer mounted in the tub so as to spray the wash water of the sump on the dishes.

### CROSS-REFERENCE TO RELATED APPLICATIONS

This application claims the benefit of Korean Application No. P2004-74092, filed on Sep. 16, 2004, which is hereby incorporated by reference as if fully set forth herein.

### ACKGROUND OF THE INVENTION

1. Field of the Invention

The present invention relates to a dishwasher, and more particularly, to a sump for receiving wash water in the dishwasher.

2. Discussion of the Related Art

A dishwasher is an apparatus for automatically washing and drying dishes by spraying wash water on dishes. The dishwasher is normally provided in a tub, and includes at least one rack, a sump for storing wash water, and at least one sprayer provided around the rack so as to spray wash water on dishes put on the rack.

In the dishwasher, the sump is mounted at a bottom of the tub so as to retrieve water sprayed on the dishes. In more detail, a flange formed at an upper part of the sump is coupled with a bottom surface of the tub via a coupling member. Since the flange has a predetermined thickness, a height difference corresponding to the thickness of the flange is generated between the bottom surface of the tub and the upper part of the sump.

Accordingly, due to the height difference, the sprayed wash water is unable to be collected at the sump, and partially remains on the bottom surface of the tub. The remaining wash water is easily decayed, thereby propagating bacteria and generating a bad smell.

### SUMMARY OF THE INVENTION

Accordingly, the present invention is directed to a dishwasher that substantially obviates one or more problems due to limitations and disadvantages of the related art.

An object of the present invention is to provide a dishwasher for completely collecting used wash water into a sump, the wash water in a tub.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dishwasher is provided, the dishwasher comprising a housing; a tub provided in the housing and receiving dishes to be washed; a sump provided at the tub so as to receive wash water and including an upper end configured not to protrude from a bottom surface of the tub; and a sprayer mounted in the tub so as to spray the wash water of the sump on the dishes.

The upper end of the sump lies in a common plane with the bottom surface of the tub, or below the bottom surface of the tub.

The tub supports the upper end of the sump to sink downwardly from the bottom surface of the tub to a predetermined depth. In more detail, the tub comprises an opening formed at a bottom thereof and receiving the sump inserted thereto.

The tub comprises an extension extended from the opening and supporting the sump, and the extension is sunken from the bottom surface of the tub to a predetermined depth. The sump comprises a flange formed at an upper end thereof and rested on the extension.

The sump is configured to be directly coupled with the tub without any fastening member. In more detail, the sump is configured to be directly engaged with a circumferential portion of the opening so as to be coupled with the tub.

The sump further comprises a hook configured to be engaged with a circumferential portion of the opening, and the tub further comprises a skirt downwardly extended from the opening and latching the hook.

Meanwhile, the dishwasher further comprising a sealing member provided between the tub and the sump. Desirably, the sealing member is not protruded from the bottom surface of the tub.

Due to the present invention, wash water in the tub is completely collected into the sump, and sump is capable of being easily and quickly coupled with the tub.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a schematic view showing a dishwasher in accordance with the present invention;

FIG. 2 illustrates a cross sectional view showing a coupling part between a tub and a sump in the dishwasher in accordance with the present invention; and

FIG. 3 illustrates a bottom perspective view showing a sump of the dishwasher in accordance with the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

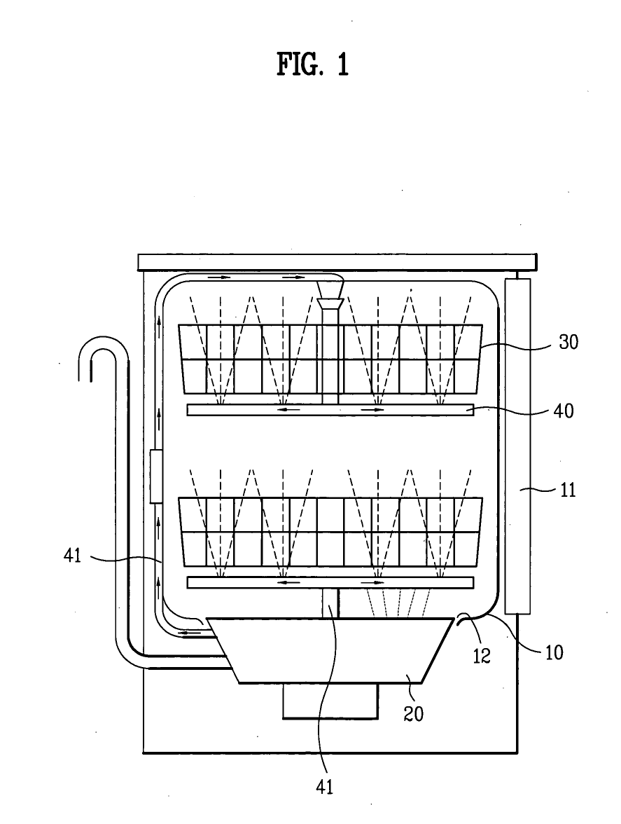

FIG. 1 illustrates a schematic view showing a dishwasher in accordance with the present invention. In the dishwasher of the present invention, a tub 10 is provided in a housing of the dishwasher, and a washing chamber is formed by a door 11 provided in front of the tub 10. In the washing chamber, at least one rack 30 for receiving dishes is provided in the washing chamber. The rack 30 is capable of being withdrawn to an outside of the washing chamber when the door 11 is opened.

A pump (not shown) for pumping the wash water to the sprayer 40 is coupled with the sump 20. The pump includes a motor (not shown) coupled with a side of the sump 20, and an impeller (not shown) provided in the sump 20 and coupled with the motor. Accordingly, when the motor is operated, the impellor rotates and pumps the wash water in the sump 20 to the sprayer 40 through a duct 41. The sprayer 40 is supplied with water pumped at the pump, and generally mounted under the rack. A nozzle (not shown) is provided at the sprayer 40, and the pumped water is sprayed into the washing chamber through the nozzle of the sprayer 40.

The sprayer is rotatably mounted, and the nozzle is oriented to be inclined. The sprayer 40 is rotated by a reaction force exerted from the water sprayed from the nozzle at an angle [5]. Accordingly, the sprayed wash water is evenly sprayed into the washing chamber and thus the dishes placed on the rack 30 are washed clean.

The used wash water is retrieved into the sump 20 as mentioned above and repeatedly sprayed into the washing chamber by the sprayer 40. When a plurality of times of washing or rinsing is completed, the used wash water is discharged from the sump 20 to an outside of the dishwasher.

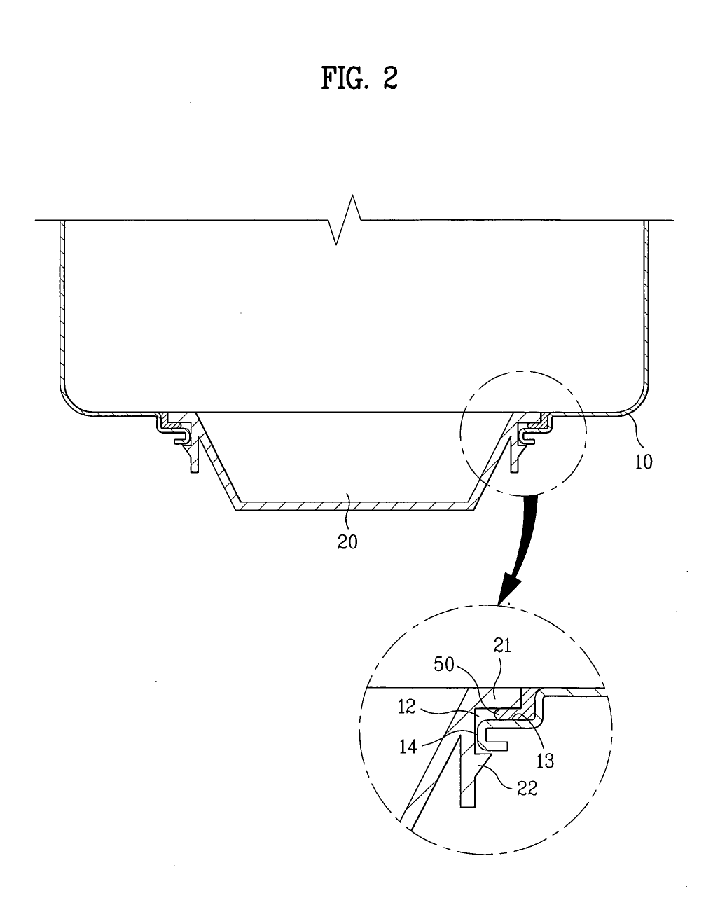

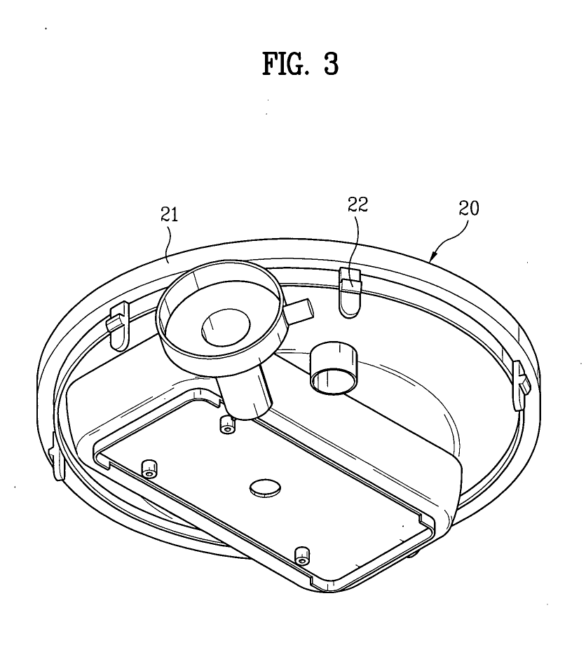

In the dishwasher as mentioned above, the sump 20 is formed as a separated member and coupled with the tub 10. A coupling structure of the sump 20 and the tub 10 will be described in more detail. FIG. 2 illustrates a cross sectional view showing a coupling part between a tub and a sump in the dishwasher in accordance with the present invention, and FIG. 3 illustrates a bottom perspective view showing a sump of the dishwasher in accordance with the present invention.

The tub 10 includes an opening 12 formed at a bottom thereof, and the sump 20 is inserted into the opening 12. The tub 10 has an extension 13 extended inwardly from the opening 12. The extension 13 actually corresponds to a circumferential portion of the opening 12 and is formed by bending the circumferential portion. The extension 13 serves to support the sump 20, and, desirably, is formed over the entire circumference of the opening 12 so as to stably support the sump 20. Meanwhile, the sump 20 includes a flange 21 formed at an upper end thereof and extended in a radius direction.

The flange 21 is rested on the extension 13, and thus the sump 20 is stably supported by the tub 10. The flange 21 is also formed over the entire circumference of the upper end in the sump so as to be stably supported by the extension 13. When an upper end of the sump 20, i.e., the flange 21, is protruded form a bottom surface of the tub 10, a part of the sprayed water remains on the bottom surface of the tub 10 because of height difference between the upper end and the bottom surface of the tub 10. The remaining water causes a bad smell and the propagation of bacteria.

Accordingly, as illustrated, the extension 13 is sunken downwardly from the bottom surface of the tub 10 to a predetermined depth so as to prevent the upper end of the sump 20 from being protruded. Since the extension 13 corresponds to the circumferential portion of the opening 12 as mentioned above, the circumferential portion of the opening is actually sunken from the bottom surface of the tub 10 to a predetermined depth.

In more detail, the extension 13 may be sunken to a depth corresponding to thickness of the flange 12. Accordingly, the upper end of the sump 20 is not protruded from the bottom surface of the tub 10 but lies in a common plane with the bottom surface of the tub 10 [7]. The extension 13 may be sunken to a depth larger than the thickness of the flange 12. In this case, the upper end of the sump 20 lies below the bottom surface of the tub 10.

As a result, the tub 10 holds the upper end of the sump 20 via the extension 13 so as to be sunken from the bottom surface of the tub 10 to a predetermined depth. The upper end of the sump 20 is not protruded from the tub 20 but positioned in the common plane [7] with the bottom surface of the tub 10, or below the bottom surface. Accordingly, the wash water in the tub 10 is completely collected into the sump 20 and thereby fundamentally preventing bacteria from being propagated and a bad smell from being generated.

Desirably, the sump 20 is configured to be directly engaged with the circumferential portion of the opening 12. In more detail, the sump 20 includes at least one hook structured to be engaged with the circumferential portion of the opening 12. Desirably, the sump 20 includes a plurality of hooks 22 formed thereat. The plurality of hooks 22 is formed adjacent to the flange 21. The tub 10 includes a skirt 14 so as to latch the hook 22. The skirt 14 is extended downwardly from the circumferential portion of the opening 12, i.e., from the extension 13. When the sump 20 is inserted into the opening 12, the hook 22 is elastically coupled with the hook 22 and the skirt 14. Accordingly, the sump 20 may be directly coupled with the tub 10 via the hook 22 and the skirt 14 without any fastening member such as a bolt. As a result, a fabricating time is reduced by such mechanism, and thereby increasing productivity.

In order to prevent the wash water from leaking from the tub 10, a sealing member 50 is provided between the sump 20 and the tub 10. Desirably, the sealing member 50 is mounted not to be protruded from the bottom surface of the tub 10. Therefore, the sealing member 50 is prevented from obstructing a movement of the wash water to the sump 20 so as to completely collect the wash water into the sump 20.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A dishwasher comprising:
a housing;
a tub provided in the housing and receiving dishes to be washed;
a sump provided at the tub so as to receive wash water and including an upper end configured not to protrude from a bottom surface of the tub; and
a sprayer mounted in the tub so as to spray the wash water of the sump on the dishes.

2. The dishwasher of claim 1, wherein the tub supports the upper end of the sump to sink downwardly from the bottom surface of the tub to a predetermined depth.

3. The dishwasher of claim 1, wherein the tub comprises an opening formed at a bottom thereof and receiving the sump inserted thereto.

4. The dishwasher of claim 3, wherein a circumferential portion of the opening is sunken from a bottom surface of the tub to a predetermined depth.

5. The dishwasher of claim 3, wherein the tub comprises an extension extended from the opening and supporting the sump.

6. The dishwasher of claim 5, wherein the extension is sunken from the bottom surface of the tub to a predetermined depth.

7. The dishwasher of claim 5, wherein the sump comprises a flange formed at an upper end thereof and rested on the extension.

8. The dishwasher of claim 1, wherein the sump is configured to be directly coupled with the tub without any fastening member.

9. The dishwasher of claim 3, wherein the sump is configured to be directly engaged with a circumferential portion of the opening so as to be coupled with the tub.

10. The dishwasher of claim 3, wherein the sump further comprises a hook configured to be engaged with a circumferential portion of the opening.

11. The dishwasher of claim 10, wherein the tub further comprises a skirt downwardly extended from the opening and latching the hook.

12. The dishwasher of claim 1, further comprising a sealing member provided between the tub and the sump.

13. The dishwasher of claim 12, wherein the sealing member is not protruded from the bottom surface of the tub.

14. The dishwasher of claim 1, wherein the upper end of the sump lies in a common plane with the bottom surface of the tub.

15. The dishwasher of claim 1, wherein the upper end of the sump lies below the bottom surface of the tub.
